(19) United States
(12) Patent Application Publication
(10) Pub. No.: US 2024/0375566 A1
(43) Pub. Date: Nov. 14, 2024

(54) CONDUCTIVE GLUE AS SHIELD IN HANDS ON DETECTION SENSORS

(71) Applicant: GENTHERM GMBH, Odelzhausen (DE)

(72) Inventors: Jan BESKA, Belle River (CA); Zoran PANIC, Windsor (CA)

(21) Appl. No.: 18/686,915

(22) PCT Filed: Aug. 29, 2022
(86) PCT No.: PCT/US2022/041798

§ 371 Date: Feb. 27, 2024

Related U.S. Application Data
(60) Provisional application No. 63/239,690, filed on Sep. 1, 2021.

(51) Int. Cl. B60N 2/56; B62D 1/06; H05B 1/02

(52) U.S. Cl. CPC B60N 2/5685; B62D 1/065; H05B 1/0202

(57) ABSTRACT

A heater/sensor assembly to perform heating of a surface and proximity sensing comprises a heater wire, a sensor wire, and an electrically conductive glue. The heater wire is disposed on a heater wire carrier. The heater wire carrier is electrically non-conducting. The sensor wire is disposed on a sensor wire carrier. The sensor wire carrier being electrically non-conducting. The electrically conductive glue is disposed between the heater wire carrier and the sensor wire carrier.

### CROSS-REFERENCE TO RELATED APPLICATIONS

This application claims the benefit of U.S. Provisional Application No. 63/239,690, filed on Sep. 1, 2021. The entire disclosure of the application referenced above is incorporated herein by reference.

### FIELD

The present disclosure relates generally to automotive heating and sensing systems and more particularly to using conductive glue as shield in hands on detection sensors in vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles such as partially or fully autonomous vehicles may include an autonomous vehicle control system that automatically controls driving of the vehicle under certain conditions. The autonomous vehicle control systems typically include a navigation system, an array of external sensors such as radar or Lidar sensors, and actuators that control steering, braking, and acceleration of the vehicle.

For partially autonomous vehicles, certain driving situations may require a driver to intervene and/or take over driving of the vehicle. For example, driving on a highway may be handled by the autonomous vehicle control system. Driver intervention may be requested in the event of an accident or construction on the roadway or when the vehicle starts exiting the highway. Accordingly, the vehicles need to sense whether or not an occupant's hand or hands are on the steering wheel of the vehicle prior to disengaging the vehicle control system. Sensors located in seats of the vehicle may also be used to detect the presence or absence of an occupant of the vehicle. If an occupant's presence is detected, safety restraints such as air bags and seat belt pretensioners may be selectively enabled or disabled.

### SUMMARY

A heater/sensor assembly to perform heating of a surface and proximity sensing comprises a heater wire, a sensor wire, and an electrically conductive glue. The heater wire is disposed on a heater wire carrier. The heater wire carrier is electrically non-conducting. The sensor wire is disposed on a sensor wire carrier. The sensor wire carrier is electrically non-conducting. The electrically conductive glue is disposed between the heater wire carrier and the sensor wire carrier.

In other features, a steering wheel of a vehicle comprises the heater/sensor assembly. A first adhesive layer is disposed adjacent to the heater wire on an opposite side of the heater wire carrier between the heater wire and the steering wheel of the vehicle to adhere the heater wire to the steering wheel of the vehicle. The first adhesive layer is electrically non-conducting.

In other features, the steering wheel further comprises a cover layer arranged adjacent to the sensor wire on an opposite side of the sensor wire carrier. The cover layer is electrically non-conducting. A second adhesive layer is disposed adjacent to the sensor wire on the opposite side of the sensor wire carrier between the cover layer and the sensor wire to adhere the sensor wire to the cover layer. The second adhesive layer is electrically non-conducting.

In other features, a steering wheel of a vehicle comprises the heater/sensor assembly. A first adhesive layer is disposed adjacent to the heater wire on an opposite side of the heater wire carrier between the heater wire and the steering wheel of the vehicle to adhere the heater wire to the steering wheel of the vehicle. The first adhesive layer is electrically non-conducting. A cover layer is arranged adjacent to the sensor wire on an opposite side of the sensor wire carrier. The cover layer is electrically non-conducting. A second adhesive layer is disposed adjacent to the sensor wire on the opposite side of the sensor wire carrier between the cover layer and the sensor wire to adhere the sensor wire to the cover layer. The second adhesive layer is electrically non-conducting.

In other features, the steering wheel further comprises a second adhesive layer disposed adjacent to the sensor wire on an opposite side of the sensor wire carrier. The second adhesive layer is electrically non-conducting. A foam layer is disposed on the second adhesive layer. The foam layer is electrically non-conducting.

In other features, the steering wheel further comprises a cover layer arranged adjacent to the sensor wire on the opposite side of the sensor wire carrier. The cover layer is electrically non-conducting. A third adhesive layer is disposed on the foam layer to adhere the foam layer to the cover layer. The third adhesive layer is electrically non-conducting.

In other features, a steering wheel of a vehicle comprises the heater/sensor assembly. A first adhesive layer is disposed adjacent to the heater wire on an opposite side of the heater wire carrier between the heater wire and the steering wheel of the vehicle to adhere the heater wire to the steering wheel of the vehicle. The first adhesive layer is electrically non-conducting. A second adhesive layer is disposed adjacent to the sensor wire on an opposite side of the sensor wire carrier. The second adhesive layer is electrically non-conducting. A foam layer is disposed on the second adhesive layer. The foam layer is electrically non-conducting. A cover layer is arranged adjacent to the sensor wire on the opposite side of the sensor wire carrier. The cover layer is electrically non-conducting. A third adhesive layer is disposed on the foam layer to adhere the foam layer to the cover layer. The third adhesive layer is electrically non-conducting.

In other features, a seat of a vehicle comprises the heater/sensor assembly disposed in a seat portion of the seat of the vehicle. The sensor wire is proximate to and faces an upper region of the seat portion. The heater wire faces a lower region of the seat portion. A first adhesive layer is arranged in the lower region of the seat portion and disposed adjacent to the heater wire on an opposite side of the heater wire carrier between the heater wire and the lower region of the seat portion to adhere the heater wire to the lower region of the seat portion. The first adhesive layer is electrically non-conducting.

In other features, the seat further comprises a cover layer arranged in the upper region of the seat portion adjacent to the sensor wire on an opposite side of the sensor wire carrier. The cover layer is electrically non-conducting. A second adhesive layer is disposed adjacent to the sensor wire on the opposite side of the sensor wire carrier between the cover layer and the sensor wire to adhere the sensor wire to the cover layer. The second adhesive layer is electrically non-conducting.

In other features, a seat of a vehicle comprises the heater/sensor assembly disposed in a seat portion of the seat of the vehicle. The sensor wire is proximate to and faces an upper region of the seat portion. The heater wire faces a lower region of the seat portion. A first adhesive layer is arranged in the lower region of the seat portion and disposed adjacent to the heater wire on an opposite side of the heater wire carrier between the heater wire and the lower region of the seat portion to adhere the heater wire to the lower region of the seat portion. The first adhesive layer is electrically non-conducting. A cover layer arranged in the upper region of the seat portion adjacent to the sensor wire on an opposite side of the sensor wire carrier. The cover layer is electrically non-conducting. A second adhesive layer is disposed adjacent to the sensor wire on the opposite side of the sensor wire carrier between the cover layer and the sensor wire to adhere the sensor wire to the cover layer. The second adhesive layer is electrically non-conducting.

In other features, the seat further comprises a second adhesive layer disposed adjacent to the sensor wire on an opposite side of the sensor wire carrier. The second adhesive layer is electrically non-conducting. A foam layer is disposed on the second adhesive layer. The foam layer is electrically non-conducting.

In other features, the seat further comprises a cover layer arranged in the upper region of the seat portion adjacent to the sensor wire on the opposite side of the sensor wire carrier. The cover layer is electrically non-conducting. A third adhesive layer is disposed on the foam layer to adhere the foam layer to the cover layer. The third adhesive layer is electrically non-conducting.

In other features, a seat of a vehicle comprises the heater/sensor assembly disposed in a seat portion of the seat of the vehicle. The sensor wire is proximate to and faces an upper region of the seat portion. The heater wire faces a lower region of the seat portion. A first adhesive layer is arranged in the lower region of the seat portion and disposed adjacent to the heater wire on an opposite side of the heater wire carrier between the heater wire and the lower region of the seat portion to adhere the heater wire to the lower region of the seat portion. The first adhesive layer is electrically non-conducting. A second adhesive layer is disposed adjacent to the sensor wire on an opposite side of the sensor wire carrier. The second adhesive layer is electrically non-conducting. A foam layer is disposed on the second adhesive layer. The foam layer is electrically non-conducting. A cover layer is arranged in the upper region of the seat portion adjacent to the sensor wire on the opposite side of the sensor wire carrier. The cover layer is electrically non-conducting. A third adhesive layer is disposed on the foam layer to adhere the foam layer to the cover layer. The third adhesive layer is electrically non-conducting.

In other features, a system comprises the heater/sensor assembly, a first circuit configured to control power supply to the heater wire, and a second circuit configured to output a signal to the sensor wire and to sense a capacitance based on a frequency of the signal.

In other features, the first circuit and the second circuit operate independently of each other.

In another feature, the electrically conductive glue is connected to a reference potential.

In other features, the first circuit or the second circuit output a respective signal to the electrically conductive glue.

In other features, the heater wire and the sensor wire are made of an electrically conducting material.

In other features, at least one of the heater wire and the sensor wire includes a single strand wire.

In other features, at least one of the heater wire and the sensor wire includes a multi-strand wire.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of an example of a steering wheel including a capacitive sensing and heating system with a heater/sensor assembly according to the present disclosure;

FIG. 2 is a side view of an example of a seat including a capacitive sensing and heating system with a heater/sensor assembly according to the present disclosure;

FIG. 3 shows a cross-sectional view of a structure of a heater/sensor assembly employing an electrically conductive glue as a shield according to the present disclosure;

FIG. 4 shows a cross-sectional view of another heater/sensor assembly employing an electrically conductive glue as a shield and additionally including a foam layer according to the present disclosure; and

FIG. 5 shows a non-limiting example of a capacitive sensing and heating system including a capacitive sensing controller and a heating controller according to the present disclosure.

In the drawings, reference numbers may be reused to identify similar and/or identical elements.

### DETAILED DESCRIPTION

Hands on detection sensors include capacitive sensors that are typically embedded in steering wheels along with heaters used to heat the steering wheels. In the process of fabricating and/or assembling the hands on detection sensors, a traditional glue is commonly used as a medium to adhere two layers of the sensor together and to adhere the sensor to the steering wheel. Using an electrically conductive glue instead of the traditional glue provides an electrically conducting layer that can be used as a shield to prevent noise from the heater and other controls embedded in the steering wheel from affecting the sensor. The electrically conductive glue can also be used for bonding the sensor layers together and bonding the sensor to the steering wheel. With this dual functionality (i.e., shielding in addition to bonding), the electrically conductive glue eliminates the need for an additional shield layer, reduces the sensor weight, reduces the sensor thickness, and reduces the fabrication/assembly time for the sensor.

In most modern steering wheels, in addition to the heater, a multitude of controls such as cruise control, communication (e.g., calling) controls, comfort controls (e.g., heating and cooling system controls), infotainment system controls, etc. are integrated into the steering wheels. The hands on detection sensors need to be shielded from the influence of noise sources such as the heater and other in-wheel embedded loads and devices (e.g., the various controls mentioned above). Commonly used shielding materials include metal foils, wire structures, or conductive ink. However, these shielding materials introduce an additional layer in the sensor structure and additional processing in the fabrication of these sensors.

Instead, an electrically conductive glue can be disposed between the sensor electrodes and the heater wire. During operation, the electrically conductive glue can be connected to ground or driven by an active signal to eliminate the switching noise from the heater and to reduce a parasitic capacitance of the sensor electrodes. This approach improves the signal to noise ratio of the capacitive sensor, which in turn improves the sensitivity of the hands on detection sensor. Additionally, this approach reduces the influence of temperature (e.g., from the co-located heater) on the capacitive sensing. Consequently, this approach provides reliable capacitive sensing in the steering wheel environment, which includes a heating system and various other embedded loads and devices. The same approach can also be used in other interior heating applications used in vehicles where capacitive sensing is used (e.g., in seats). These and other features of the present disclosure are described below in detail.

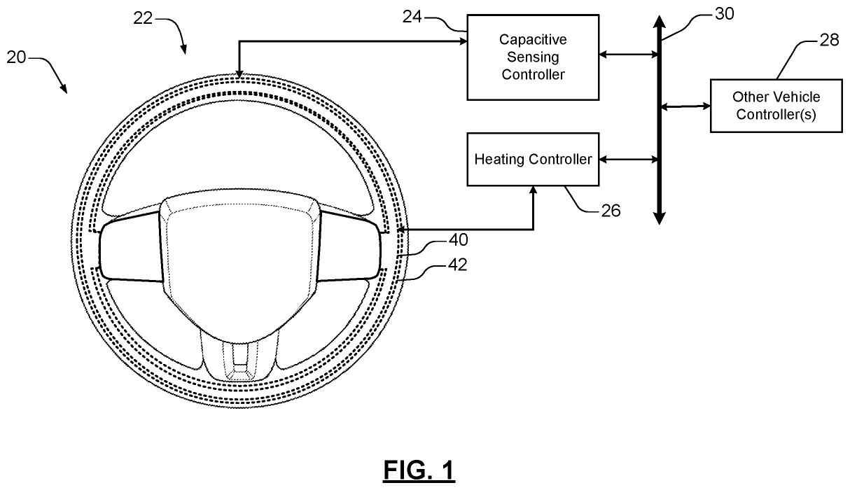

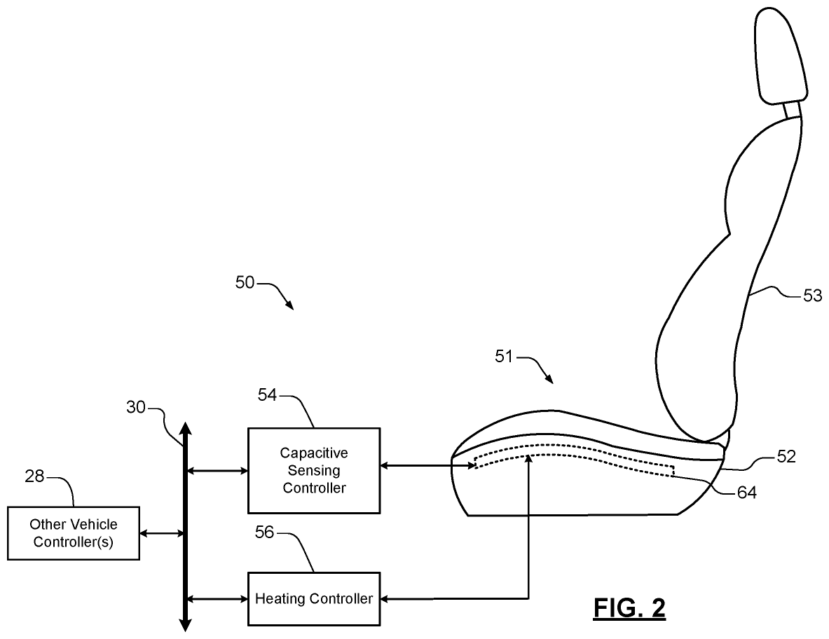

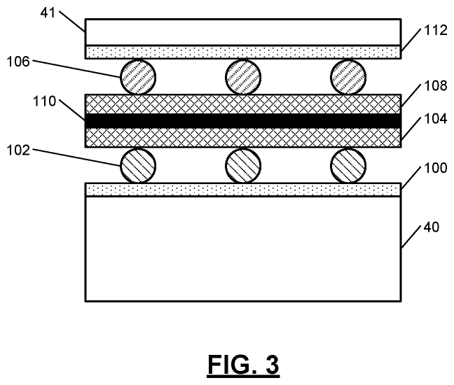

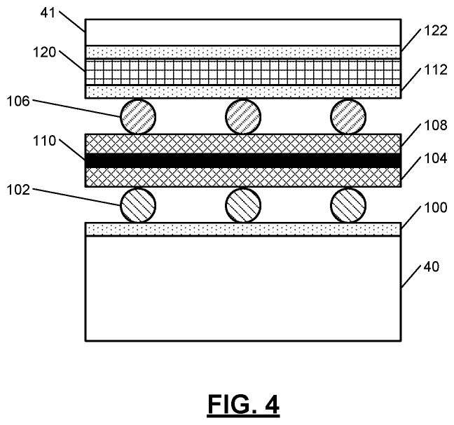

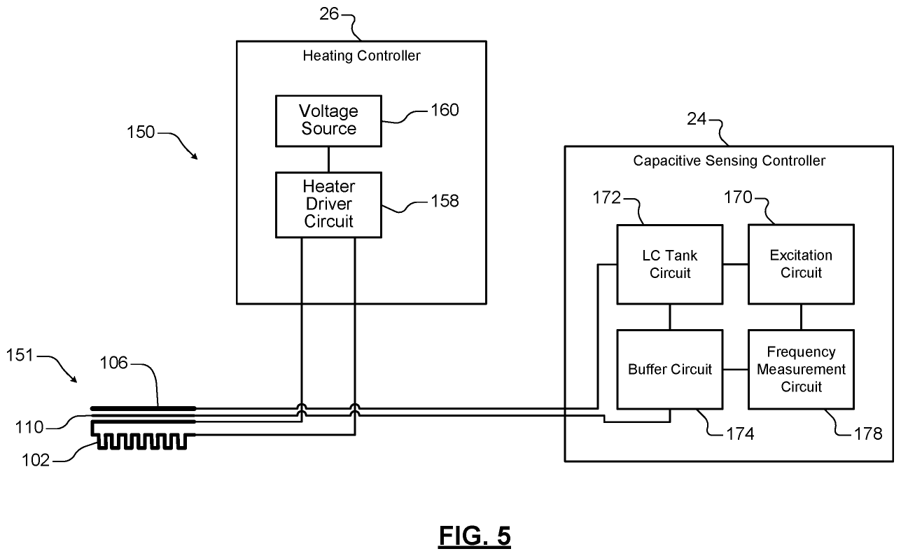

The present disclosure is organized as follows. Initially, examples of the hands on detection sensor and the heater are shown and described with reference to FIGS. 1 and 2. Subsequently, the structure of the hands on detection sensor and the heater employing the electrically conductive glue is shown and described with reference to FIGS. 3 and 4. A non-limiting example of a capacitive sensing and heating system comprising a capacitive sensing controller and a heating controller is shown and described with reference to FIG. 5.

FIG. 1 shows a capacitive sensing and heating system 20 for a steering wheel 22 of a vehicle. The capacitive sensing and heating system 20 includes a capacitive sensing controller 24 and a heating controller 26. The steering wheel 22 includes a heater/sensor assembly 42. The heater/sensor assembly 42 is shown and described below in further detail with reference to FIGS. 3 and 4. The heater/sensor assembly 42 is wrapped around a steering wheel base 40. In some examples, the heater/sensor assembly 42 may define a single heating zone or a plurality of heating zones. The capacitance sensing may also be performed in a single sensing zone or a plurality of sensing zones.

The capacitive sensing controller 24 senses a capacitance of the heater/sensor assembly 42. More specifically, the capacitive sensing controller 24 senses a change in the capacitance that is induced when an occupant of the vehicle places a hand or hands on the steering wheel 22 or when the occupant removes the hand or hands from the steering wheel 22. The heating controller 26 controls supply of power to the heater in the heater/sensor assembly 42. Examples of the capacitive sensing controller 24 and the heating controller 26 are described below in further detail with reference to FIG. 5.

In some examples, one or more switches (not shown) may be used by an occupant of the vehicle to actuate the capacitive sensing and/or heating of the steering wheel 22. For example, the one or more switches may include physical switches or pushbuttons (e.g., on the dashboard of the vehicle or on the steering wheel 22). In other examples, the one or more switches may include soft switches provided on a touchscreen associated with the infotainment system or another input device. In still other examples, the one or more switches can be actuated automatically in conjunction with a heating, ventilation, and air conditioning (HVAC) system (not shown).

The capacitive sensing controller 24 and the heating controller 26 are separate controllers. That is, the capacitive sensing controller 24 and the heating controller 26 are not connected to each other. The capacitive sensing controller 24 and the heating controller 26 operate independently of each other. The operations of the capacitive sensing controller 24 and the heating controller 26 are not synchronized. The capacitive sensing controller 24 and the heating controller 26 communicate with other vehicle controllers 28 via a vehicle communication bus 30. For example, the other vehicle controllers 28 may include controllers that control a climate control system (e.g., a heating and cooling system), an autonomous vehicle control system, a restraint control system, an infotainment system, and so on. For example, the vehicle communication bus 30 may include a controller area network (CAN) bus, a local interconnect network (LIN) bus, or any other communication bus/network used in the vehicle.

The capacitive sensing controller 24 and the heating controller 26 receive settings from and transmit data to the other vehicle controllers 28 via the vehicle communication bus 30. For example, the capacitive sensing controller 24 receives calibrated thresholds from one or more of the vehicle controllers 28 for capacitance sensing. For example, the heating controller 26 receives calibrated thresholds from one or more of the vehicle controllers 28 for heating control. The structural design of the heater/sensor assembly 42 is shown and described below in further detail with reference to FIGS. 3 and 4. The structural design of the heater/sensor assembly 42 allows the capacitive sensing controller 24 and the heating controller 26 to operate without interfering each other as explained below in further detail.

For example, as shown in FIG. 5, the capacitive sensing controller 24 may include a tank circuit coupled to the capacitive sensor in the heater/sensor assembly 42. The capacitive sensing controller 24 can measure the capacitance or change in the capacitance by measuring a resonant frequency or change in the resonant frequency of the tank circuit. After sensing the capacitance, the capacitive sensing controller 24 can communicate the capacitance measurement to one or more of the other vehicle controllers 28 via the vehicle communication bus 30. In some examples, the autonomous driving control system may use the sensed capacitance measurement to determine whether the driver's hand or hands are on or off the steering wheel.

FIG. 2 shows a capacitive sensing and heating system 50 for a seat 51 of the vehicle. The seat 51 includes a seat portion 52 and a backrest portion 53. A heater/sensor assembly 64 is disposed in the seat portion 52. The heater/sensor assembly 64 may include a single zone or a plurality of zones for heating and/or capacitive sensing.

The capacitive sensing and heating system 50 includes a capacitive sensing controller 54 and a heating controller 56. The capacitive sensing controller 54 senses a capacitance of the heater/sensor assembly 64. Specifically, the capacitive sensing controller 54 senses a change in the capacitance that is induced when an occupant of the vehicle occupies the seat 51 or when the occupant vacates the seat 51. The heating controller 56 controls supply of power to the heater in the heater/sensor assembly 64. In some examples, a switch (not shown) may be used by an occupant of the vehicle to actuate heating of the seat 51. The switch can be similar to that described above with reference to FIG. 1. Therefore, the description of the switch is not repeated for brevity.

The capacitive sensing controller 54 and the heating controller 56 are separate controllers. That is, the capacitive sensing controller 54 and the heating controller 56 are not connected to each other. The capacitive sensing controller 54 and the heating controller 56 operate independently of each other. The operations of the capacitive sensing controller 54 and the heating controller 56 are not synchronized. The capacitive sensing controller 54 and the heating controller 56 communicate with other vehicle controllers 28 via a vehicle communication bus 30. For example, the other vehicle controllers 28 may include controllers that control a climate control system (e.g., a heating and cooling system), an autonomous vehicle control system, a restraint control system, an infotainment system, and so on. For example, the vehicle communication bus 30 may include a CAN bus, a LIN bus, or any other communication bus/network used in the vehicle.

The capacitive sensing controller 54 and the heating controller 56 receive settings from and transmit data to the other vehicle controllers 28 via the vehicle communication bus 30. For example, the capacitive sensing controller 54 receives calibrated thresholds from one or more of the vehicle controllers 28 for capacitance sensing. For example, the heating controller 56 receives calibrated thresholds from one or more of the vehicle controllers 28 for heating control. The structural design of the heater/sensor assembly 64 is similar to the structural design of the heater/sensor assembly 42 shown and described below in further detail with reference to FIGS. 3 and 4. The structural design of the heater/sensor assembly 64 allows the capacitive sensing controller 54 and the heating controller 56 to operate without interfering each other.

For example, as shown and described with reference to FIG. 5, the capacitive sensing controller 54 may include a tank circuit coupled to the capacitive sensor in the heater/sensor assembly 64. The capacitive sensing controller 54 can measure the capacitance or change in the capacitance by measuring a resonant frequency or change in the resonant frequency of the tank circuit. After sensing the capacitance, the capacitive sensing controller 54 can communicate the capacitance measurement to one or more of the other vehicle controllers 28 via the vehicle communication bus 30. In some examples, the autonomous driving control system may use the sensed capacitance measurement to determine the presence or absence of an occupant in the seat 51.

FIG. 3 shows an example of the heater/sensor assembly 42. The heater/sensor assembly 64 is similar to the heater/sensor assembly 42. The heater/sensor assembly 42 is wrapped around the steering wheel base 40. The heater/sensor assembly 42 is adhered to the steering wheel base 40 using an adhesive layer (called a first adhesive layer) 100. The first adhesive layer 100 is electrically non-conducting.

The heater/sensor assembly 42 includes a heater wire 102 disposed on a heater wire carrier 104. The heater wire 102 is made of an electrically conducting material (e.g., a metal, an alloy, etc.). The heater wire carrier 104 is made of an electrically non-conducting material. The heater wire 102 can include a single multi-strand wire or two or more multi-strand wires. In some implementations, the heater wire 102 can be arranged in multiple zones. The heater wire carrier 104 is electrically non-conducting.

The heater/sensor assembly 42 includes a sensor wire 106 that forms a sensor electrode for capacitive sensing. The sensor wire 106 is disposed on a sensor wire carrier 108. The sensor wire 106 is made of an electrically conducting material (e.g., a metal, an alloy, etc.). The sensor wire carrier 108 is made of an electrically non-conducting material. The sensor wire 106 can also include a single multi-strand wire or two or more multi-strand wires. In some implementations, the sensor wire 106 can also be arranged in multiple zones. The sensor wire carrier 108 is electrically non-conducting.

A cover layer 41 of leather or other suitable material covers the heater/sensor assembly 42. The cover layer 41 is electrically non-conducting. The cover layer 41 is adhered to the sensor wire carrier 108 using an adhesive (called a second adhesive layer) 112. The second adhesive layer 112 is also electrically non-conducting.

Typically, in the process of fabricating and/or assembling the hands on detection sensors, a traditional glue is commonly used as a medium to adhere the sensor and heater layers of the sensor together. Instead, according to the present disclosure, in heater/sensor assembly 42, the sensor wire carrier 108 and the heater wire carrier 104 are bonded together using an electrically conductive glue 110.

Using the electrically conductive glue 110 instead of the traditional glue provides an electrically conducting layer that can be used as a shield to prevent noise from the heater wire 102 and other controls embedded in the steering wheel 22 (shown in FIG. 1) from affecting the capacitive sensing performed by the sensor wire 106. The electrically conductive glue 110 provides electrical shielding in addition to mechanical bonding. The electrically conductive glue 110 eliminates the need for an additional shield layer, reduces the sensor weight, reduces the sensor thickness, and reduces the fabrication/assembly time for the sensor.

Specifically, the heater/sensor assembly 42 needs to be shielded from the influence of noise sources such as the heater wire 102 and other in-wheel embedded loads and devices (e.g., the various controls mentioned above). Commonly used shielding materials include metal foils, wire structures, or conductive ink. However, these shielding materials introduce an additional layer in the sensor structure and additional processing in the fabrication of these sensors.

Instead, the electrically conductive glue 110 is disposed between the sensor wire carrier 108 and the heater wire carrier 104. During operation, the electrically conductive glue 110 can be connected to ground or driven by an active signal to eliminate the switching noise from the heater wire 102 and to reduce a parasitic capacitance of sensor electrodes. This approach improves the signal to noise ratio of the capacitive sensor, which in turn improves the sensitivity of the heater/sensor assembly 42 for capacitive sensing. Additionally, this approach reduces the influence of temperature (e.g., from the co-located heater wire 102) on the capacitive sensing performed by the sensor wire 106 in the heater/sensor assembly 42. Consequently, this approach provides reliable capacitive sensing in the steering wheel environment, which includes the heater wire 102 and various other embedded loads and devices.

More specifically, the heater/sensor assembly 42 for performing heating of a surface and proximity sensing in the steering wheel 22 of the vehicle is constructed and embedded in the steering wheel 22 as follows. The heater wire 102 is disposed on the heater wire carrier 104. The heater wire carrier 104 is electrically non-conducting. The sensor wire 106 is disposed on the sensor wire carrier 108. The sensor wire carrier 108 is electrically non-conducting. The electrically conductive glue 110 is disposed between the heater wire carrier 104 and the sensor wire carrier 108. The electrically conductive glue 110 bonds the heater wire carrier 104 and the sensor wire carrier 108. Additionally, the electrically conductive glue 110 electrically shields the sensor wire 106 from noise from the heater wire 102 and other noise sources in the steering wheel 22.

The first adhesive layer 100 is disposed adjacent to the heater wire 102 on an opposite side of the heater wire carrier 104 between the heater wire 102 and the steering wheel base 40 of the vehicle. The first adhesive layer 100 adheres the heater wire 102 to the steering wheel base 40 of the vehicle. The first adhesive layer 100 is electrically non-conducting. The cover layer 41 is arranged adjacent to the sensor wire 106 on an opposite side of the sensor wire carrier 108. The cover layer 41 is electrically non-conducting. The second adhesive layer 112 is disposed adjacent to the sensor wire 106 on the opposite side of the sensor wire carrier 108 between the cover layer 21 and the sensor wire 106. The second adhesive layer 112 adheres the sensor wire 106 to the cover layer 41. The second adhesive layer 112 is also electrically non-conducting.

FIG. 4 shows the heater/sensor assembly 42 with the addition of a foam layer 120. The foam layer 120 is arranged in the heater/sensor assembly 42 between the sensor wire 106 and the cover layer 41 as follows. The foam layer 120 is disposed on the second adhesive layer 112. The foam layer 120 is electrically non-conducting. The cover layer 41 is arranged adjacent to the sensor wire 106 on the opposite side of the sensor wire carrier 108. The cover layer 41 is electrically non-conducting. An adhesive (called a third adhesive layer) 122 is disposed on the foam layer 120 to adhere the foam layer 120 to the cover layer 41. The third adhesive layer 122 is also electrically non-conducting.

The heater/sensor assembly 64 is similar to the heater/sensor assembly 42. The heater/sensor assembly 64 for performing heating of a surface and proximity sensing in the seat 51 of the vehicle is constructed and embedded in the seat portion 52 of the seat 51 as follows. The heater/sensor assembly 64 is disposed in the seat portion 52 of the seat 51 of the vehicle. The sensor wire 106 is proximate to and facing an upper region of the seat portion 52. When an occupant occupies the seat 51, the occupant rests on the upper region of the seat portion 52. The heater wire 102 faces a lower region of the seat portion 52, which faces a chassis of the vehicle.

The first adhesive layer 100 is arranged in the lower region of the seat portion 52 and is disposed adjacent to the heater wire 102 on an opposite side of the heater wire carrier 104 between the heater wire 102 and the lower region of the seat portion 52. The first adhesive layer 100 adheres the heater wire 102 to the lower region of the seat portion 52. The first adhesive layer 100 is electrically non-conducting.

The cover layer 41 is arranged in the upper region of the seat portion 52 adjacent to the sensor wire 106 on an opposite side of the sensor wire carrier 108. The cover layer 41 is electrically non-conducting. The second adhesive layer 112 is disposed adjacent to the sensor wire 106 on the opposite side of the sensor wire carrier 108 between the cover layer 41 and the sensor wire 106. The second adhesive layer 112 adheres the sensor wire 106 to the cover layer 41. The second adhesive layer 112 is also electrically non-conducting.

In some implementations, the heater/sensor assembly 64 additionally includes the foam layer 120. The foam layer 120 is arranged in the heater/sensor assembly 64 between the sensor wire 106 and the cover layer 41 as follows. The foam layer 120 is disposed on the second adhesive layer 112. The foam layer 120 is electrically non-conducting. The cover layer 41 is arranged adjacent to the sensor wire 106 on the opposite side of the sensor wire carrier 108. The cover layer 41 is electrically non-conducting. For example, the cover layer 41 can be the upper surface (e.g., upholstery) of the seat portion 52. The cover layer 41 is arranged in the upper region of the seat portion 52 adjacent to the sensor wire 106 on the opposite side of the sensor wire carrier 108. The third adhesive layer 122 is disposed on the foam layer 120 to adhere the foam layer 120 to the cover layer 41. The third adhesive layer 122 is also electrically non-conducting.

For completeness, simplified non-limiting examples of the capacitive sensing controller 24 and the heating controller 26 are shown and described with reference to FIG. 5. The capacitive sensing controller 54 and the heating controller 56 can be similar to the capacitive sensing controller 24 and the heating controller 26. In some implementations, the capacitive sensing controller 24 and the heating controller 26 can be combined into a single controller. Similarly, the capacitive sensing controller 54 and the heating controller 56 can also be combined into a single controller.

In FIG. 5, a capacitive sensing and heating system 150 includes a heater/sensor assembly 151. The heater/sensor assembly 151 can include the heater/sensor assembly 42 or the heater/sensor assembly 64. The capacitive sensing and heating system 150 comprises the capacitive sensing controller 24 and the heating controller 26. While a single zone circuit will be described below for purposes of illustration and clarity, additional zones can be readily added.

The heating controller 26 comprises a heater driver circuit 158 that selectively supplies power from a voltage source 160 to the heater wire 102 to heat the steering wheel 22 or the seat 51. The heater driver circuit 158 supplies power to the heater wire 102 independently of the capacitive sensing controller 24.

The capacitive sensing controller 24 comprises an excitation circuit 170 that selectively outputs an excitation signal (such as a square wave or other waveform shape) to an LC tank circuit 172 that is connected to the sensing wire 106. A frequency measurement circuit 178 measures the resonant frequency of the LC tank circuit 172. When an occupant's hand (or body in case of the seat implementation) is proximate to the sensing wire 106, the capacitance of the combined circuit varies. The variation in capacitance due to the presence or absence of the occupant's hands on the steering wheel (or due to the presence or absence of the occupant in the seat 51) affects a resonant frequency of the LC tank circuit 172. The capacitive sensing controller 24 measures the variation in capacitance based on the changes in the resonant frequency of the LC tank circuit 172.

Based on the variation in the capacitance, the capacitive sensing controller 24 detects the presence or absence of the occupant's hands on the steering wheel (or due to the presence or absence of the occupant in the seat 51). The capacitive sensing controller 24 measures the variation in capacitance independently of the heating controller 26. That is, the operations of the capacitive sensing controller 24 and the heating controller 26 are not and need not be synchronized. The capacitive sensing controller 54 and the heating controller 56 operate similar to the capacitive sensing controller 24 and the heating controller 26.

The electrically conductive glue 110 provides an electrical shield and reduces the effect of stray capacitance between the sensing wire 106 and the heater wire 102. The electrically conductive glue 110 can be connected to ground or can be driven by active signal. For example, the electrically conductive glue 110 can be driven by the signal output to the sensor wire 106 by the capacitive sensing controller 26. Alternatively, the electrically conductive glue 110 can be driven by the signal output to the heater wire 102 by the heating controller 24.

A buffer circuit 174 actively drives the electrically conductive glue 110 using the same signal that is supplied to the sensing wire 106. The buffer circuit 174 prevents the sensing wire 106 from loading the tank circuit 172. That is, due to the buffer circuit 174, the resonant frequency of the tank circuit 172 is not affected by the electrically conductive glue 110.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between controllers, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “controller” may be replaced with the term “circuit.” The term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The controller may include one or more interface circuits. In some examples, the interface circuits may include wired or wireless interfaces that are connected to a local area network (LAN), the Internet, a wide area network (WAN), or combinations thereof. The functionality of any given controller of the present disclosure may be distributed among multiple controllers that are connected via interface circuits. For example, multiple controllers may allow load balancing.

The term code, as used above, may include software, firmware, and/or microcode, and may refer to programs, routines, functions, classes, data structures, and/or objects. The term shared processor circuit encompasses a single processor circuit that executes some or all code from multiple controllers. The term group processor circuit encompasses a processor circuit that, in combination with additional processor circuits, executes some or all code from one or more controllers. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple controllers. The term group memory circuit encompasses a memory circuit that, in combination with additional memories, stores some or all code from one or more controllers.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A heater/sensor assembly to perform heating of a surface and proximity sensing, comprising:
a heater wire disposed on a heater wire carrier, the heater wire carrier being electrically non-conducting;
a sensor wire disposed on a sensor wire carrier, the sensor wire carrier being electrically non-conducting; and
an electrically conductive glue disposed between the heater wire carrier and the sensor wire carrier.

2. A steering wheel of a vehicle comprising:
the heater/sensor assembly of claim 1; and
a first adhesive layer disposed adjacent to the heater wire on an opposite side of the heater wire carrier between the heater wire and the steering wheel of the vehicle to adhere the heater wire to the steering wheel of the vehicle, the first adhesive layer being electrically non-conducting.

3. The steering wheel of claim 2 further comprising:
a cover layer arranged adjacent to the sensor wire on an opposite side of the sensor wire carrier, the cover layer being electrically non-conducting; and
a second adhesive layer disposed adjacent to the sensor wire on the opposite side of the sensor wire carrier between the cover layer and the sensor wire to adhere the sensor wire to the cover layer, the second adhesive layer being electrically non-conducting.

4. A steering wheel of a vehicle comprising:
the heater/sensor assembly of claim 1;
a first adhesive layer disposed adjacent to the heater wire on an opposite side of the heater wire carrier between the heater wire and the steering wheel of the vehicle to adhere the heater wire to the steering wheel of the vehicle, the first adhesive layer being electrically non-conducting;
a cover layer arranged adjacent to the sensor wire on an opposite side of the sensor wire carrier, the cover layer being electrically non-conducting; and
a second adhesive layer disposed adjacent to the sensor wire on the opposite side of the sensor wire carrier between the cover layer and the sensor wire to adhere the sensor wire to the cover layer, the second adhesive layer being electrically non-conducting.

5. The steering wheel of claim 2 further comprising:
a second adhesive layer disposed adjacent to the sensor wire on an opposite side of the sensor wire carrier, the second adhesive layer being electrically non-conducting; and
a foam layer disposed on the second adhesive layer, the foam layer being electrically non-conducting.

6. The steering wheel of claim 5 further comprising
a cover layer arranged adjacent to the sensor wire on the opposite side of the sensor wire carrier, the cover layer being electrically non-conducting; and
a third adhesive layer disposed on the foam layer to adhere the foam layer to the cover layer, the third adhesive layer being electrically non-conducting.

7. A steering wheel of a vehicle comprising:
the heater/sensor assembly of claim 1;
a first adhesive layer disposed adjacent to the heater wire on an opposite side of the heater wire carrier between the heater wire and the steering wheel of the vehicle to adhere the heater wire to the steering wheel of the vehicle, the first adhesive layer being electrically non-conducting;
a second adhesive layer disposed adjacent to the sensor wire on an opposite side of the sensor wire carrier, the second adhesive layer being electrically non-conducting;
a foam layer disposed on the second adhesive layer, the foam layer being electrically non-conducting;
a cover layer arranged adjacent to the sensor wire on the opposite side of the sensor wire carrier, the cover layer being electrically non-conducting; and
a third adhesive layer disposed on the foam layer to adhere the foam layer to the cover layer, the third adhesive layer being electrically non-conducting.

8. A seat of a vehicle comprising:
the heater/sensor assembly of claim 1 disposed in a seat portion of the seat of the vehicle, the sensor wire being proximate to and facing an upper region of the seat portion, the heater wire facing a lower region of the seat portion; and
a first adhesive layer arranged in the lower region of the seat portion and disposed adjacent to the heater wire on an opposite side of the heater wire carrier between the heater wire and the lower region of the seat portion to adhere the heater wire to the lower region of the seat portion, the first adhesive layer being electrically non-conducting.

9. The seat of claim 8 further comprising:
a cover layer arranged in the upper region of the seat portion adjacent to the sensor wire on an opposite side of the sensor wire carrier, the cover layer being electrically non-conducting; and
a second adhesive layer disposed adjacent to the sensor wire on the opposite side of the sensor wire carrier between the cover layer and the sensor wire to adhere the sensor wire to the cover layer, the second adhesive layer being electrically non-conducting.

10. A seat of a vehicle comprising:
the heater/sensor assembly of claim 1 disposed in a seat portion of the seat of the vehicle, the sensor wire being proximate to and facing an upper region of the seat portion, the heater wire facing a lower region of the seat portion;
a first adhesive layer arranged in the lower region of the seat portion and disposed adjacent to the heater wire on an opposite side of the heater wire carrier between the heater wire and the lower region of the seat portion to adhere the heater wire to the lower region of the seat portion, the first adhesive layer being electrically non-conducting;
a cover layer arranged in the upper region of the seat portion adjacent to the sensor wire on an opposite side of the sensor wire carrier, the cover layer being electrically non-conducting; and
a second adhesive layer disposed adjacent to the sensor wire on the opposite side of the sensor wire carrier between the cover layer and the sensor wire to adhere the sensor wire to the cover layer, the second adhesive layer being electrically non-conducting.

11. The seat of claim 8 further comprising:
a second adhesive layer disposed adjacent to the sensor wire on an opposite side of the sensor wire carrier, the second adhesive layer being electrically non-conducting; and
a foam layer disposed on the second adhesive layer, the foam layer being electrically non-conducting.

12. The seat of claim 11 further comprising:
a cover layer arranged in the upper region of the seat portion adjacent to the sensor wire on the opposite side of the sensor wire carrier, the cover layer being electrically non-conducting; and
a third adhesive layer disposed on the foam layer to adhere the foam layer to the cover layer, the third adhesive layer being electrically non-conducting.

13. A seat of a vehicle comprising:
the heater/sensor assembly of claim 1 disposed in a seat portion of the seat of the vehicle, the sensor wire being proximate to and facing an upper region of the seat portion, the heater wire facing a lower region of the seat portion;
a first adhesive layer arranged in the lower region of the seat portion and disposed adjacent to the heater wire on an opposite side of the heater wire carrier between the heater wire and the lower region of the seat portion to adhere the heater wire to the lower region of the seat portion, the first adhesive layer being electrically non-conducting;
a second adhesive layer disposed adjacent to the sensor wire on an opposite side of the sensor wire carrier, the second adhesive layer being electrically non-conducting;
a foam layer disposed on the second adhesive layer, the foam layer being electrically non-conducting;
a cover layer arranged in the upper region of the seat portion adjacent to the sensor wire on the opposite side of the sensor wire carrier, the cover layer being electrically non-conducting; and
a third adhesive layer disposed on the foam layer to adhere the foam layer to the cover layer, the third adhesive layer being electrically non-conducting.

14. A system comprising:
the heater/sensor assembly of claim 1;
a first circuit configured to control power supply to the heater wire; and
a second circuit configured to output a signal to the sensor wire and to sense a capacitance based on a frequency of the signal.

15. The system of claim 14 wherein the first circuit and the second circuit operate independently of each other.

16. The system of claim 14 wherein the electrically conductive glue is connected to a reference potential.

17. The system of claim 14 wherein the first circuit or the second circuit output a respective signal to the electrically conductive glue.

18. The heater/sensor assembly of claim 1 wherein the heater wire and the sensor wire are made of an electrically conducting material.

19. The heater/sensor assembly of claim 1 wherein at least one of the heater wire and the sensor wire includes a single strand wire.

20. The heater/sensor assembly of claim 1 wherein at least one of the heater wire and the sensor wire includes a multi-strand wire.
